(19) United States
(12) Patent Application Publication
(10) Pub. No.: US 2003/0115592 A1
(43) Pub. Date: Jun. 19, 2003

(54) Method and apparatus for selecting rating limits in a parental control system

(76) Inventor: Carolynn Rae Johnson, Indianapolis, IN (US)

Correspondence Address: JOSEPH S. TRIPOLI, THOMSON MULTIMEDIA LICENSING INC., 2 INDEPENDENCE WAY, P. O. BOX 5312, PRINCETON, NJ, 08543-5312, US

(21) Appl. No.: 10/024,924

(22) Filed: Dec. 19, 2001

(51) Int. Cl. H04N 7/16; H04N 5/445

(52) U.S. Cl. 725/28; 725/25; 725/30; 725/46

(57) ABSTRACT

Rating limits, which define whether programs are to be blocked or are deemed to be acceptable, are selected in a program content filtering system. For that purpose information about a rating example is reproduced and at least one recommended rating assigned to the rating example is supplied. An user indication about the acceptability of said rating example is detected and assigned to the recommended rating. A rating limit is derived in response to the user indication. The above steps can be repeated if needed to provide sufficient data to enable deriving one or more rating limits from the user indications assigned to the ratings.

### FIELD OF THE INVENTION

The invention relates to a method and an apparatus for selecting rating limits in a parental control system.

### BACKGROUND OF THE INVENTION

Television broadcasts may contain content that could be harmful to children like violence or sexual content. Therefore, various parental control systems have been developed for blocking inappropriate programs or channels.

In the U.S. a blocking system has been employed for television content advisories (ratings) using the so-called V-chip. The ratings are encoded by the broadcaster during the vertical blanking period of an NTSC television signal, more specifically during line 21 of field 2, using a data format referred to as Extended Data Services or XDS. The XDS data format is similar to the format of closed caption data in the U.S. which is encoded in line 21 of field 1 of an NTSC television signal. The data formats for both XDS and closed caption information are specified in the EIA-608 standard developed by the Consumer Electronics Association (CEA) in the U.S. The rating signal is transmitted together with the respective TV show and detected by the V-chip system implemented in the TV apparatus. The system decodes the line 21 data, compares it with the allowed rating and then either blocks the signal or lets it through. Note that references herein to TV apparatus, TV systems, TV set, and/or video signal processing systems or apparatus are intended to encompass any system, either with or without a display device, for processing a video or TV signal that includes auxiliary information, such as XDS data, for providing ratings information. Examples of such systems include televisions, VCR, DVD, satellite signal receiver, set-top boxes, cable boxes, etc.

A system such as V-Chip requires parents to identify the ratings they wish to block on two different rating systems: the TV Parental Guidelines, and the Motion Picture Association of America (MPAA) movie ratings, which are used on unedited movies shown on premium cable channels.

The TV Parental Guidelines consist of an age-based rating that indicates the age group for which a particular program is considered suitable and a content-based rating.

The age-based ratings of the TV Parental Guidelines are standardized as follows:

TV-Y: Designed to be appropriate for all children, especially for ages 2-6.

TV-Y7: Designed for children age 7 and above.

TV-G: Most parents would find the program suitable for all ages.

TV-PG: Contains material that parents might find unsuitable for younger children.

TV-14: Contains some material that many parents would find inappropriate for children under 14.

TV-MA: Specifically designed to be viewed by adults and unsuitable for children under 17.

These age-based ratings may be combined with one or more letters indicating content with higher levels of violence (V), sexual situations (S), coarse or crude indecent language (L), suggestive dialogue (D) or fantasy violence (FV). For example, a show rated TV-PG that contains higher than usual levels of violence and sexual situations would be labelled TV-PG-V-S.

The MPAA movie ratings are also divided into age groups according to the amount of profanity, violence, and sex found in the movies. However, the movie ratings differ from the above mentioned television ratings and use the following different ratings:

G: All ages admitted.

PG: Some material may not be suitable for children.

PG-13: Some material may be inappropriate for children under 13

R: Under 17 requires accompanying parent or guardian.

NC-17: Requires all persons to be over the age of 17

X: Restricted to adults.

The setting up of the rating limits is usually done by means of onscreen directions offered for the two separate ratings systems. For example, for movie ratings the user may highlight “PG-13” indicating that all programs above this rating should be blocked, and all programs below this rating should be deemed acceptable. For the TV rating limits the user also has to select an age-based rating, e.g. “TV-14”. In addition, for TV rating limits the user must also determine whether to block certain types of content, wherein the content-based rating may be defined differently for the various age-based ratings.

Due to the different rating systems, the various possible combinations of age-based and content-based ratings for the TV rating limits and the abstract definition of the rating limits the user tends to be confused by the setup routines required to create the rating limits. Therefore, programs that the parent would normally allow the household children to view may inadvertently be blocked or programs that the parent would normally want to block may inadvertently be allowed. This results in a low acceptance of the V-chip system, which means that, although implemented, only a minor percentage of the parents are using this system.

### SUMMARY OF THE INVENTION

Rating limits, which define whether programs are to be blocked or are deemed to be acceptable, are selected in a program content filtering system. For that purpose information about a rating example is reproduced and at least one recommended rating assigned to the rating example is supplied. An user indication about the acceptability of said rating example is detected and assigned to the recommended rating. A rating limit is derived in response to the user indication. The above steps can be repeated if needed to provide sufficient data to enable deriving one or more rating limits from the user indications assigned to the ratings.

### BRIEF DESCRIPTION OF THE DRAWINGS

Exemplary embodiments of the invention are described on the basis of the drawings, in which

FIG. 1: is a block diagram of an apparatus suitable for an interactive setup of rating limits using EPG data;

FIG. 2: is a flow diagram of a method for the interactive setup;

FIG. 3: is an on-screen display of an introduction into the interactive setup;

FIG. 4: is an on-screen display of an example for the interactive setup;

FIG. 5: is an on-screen display of a further example for the interactive setup;

FIG. 6: is an on-screen display of a further example for the interactive setup;

FIG. 7: is an on-screen display for a message demanding additional information;

FIG. 8: is an on-screen display of a summary of ratings limits.

### DETAILED DESCRIPTION OF PREFERRED EMBODIMENTS

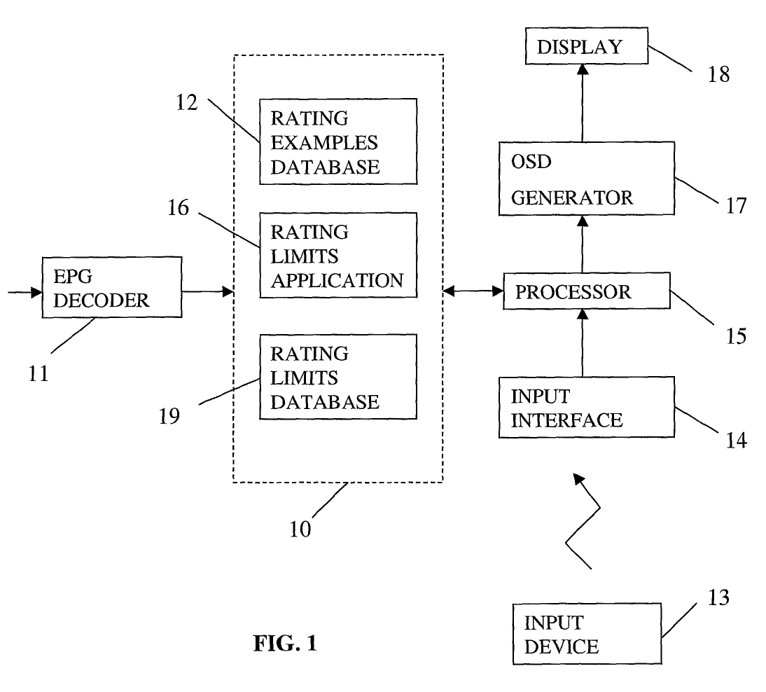

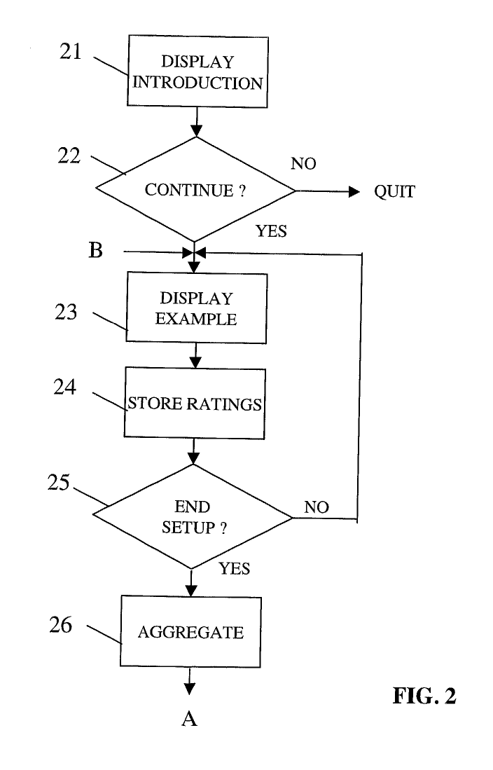

FIG. 1 depicts a high level block diagram of an embodiment suitable for an interactive setup of rating limits using EPG data, implemented in a receiver device, e.g. in a TV set or set top box. Only parts relevant for the invention are described, while usual components like a tuner or demodulator are not shown.

An EPG (Electronic Program Guide) decoder 11 receives a signal comprising data for establishing an EPG and data for the interactive setup of rating limits, especially up-to-date rating examples. The data for rating examples are decoded and stored in a rating examples database 12, from which they can be accessed later upon request of the user.

An input device 13 allows calling up the interactive feature for setting up rating limits. The input device 13 may be any device utilized to provide input to devices like TV sets, set top boxes, computers etc. Examples of the input device 13 include a remote control, a keypad, a computer mouse, a microphone, a touch screen, and the like. An input interface 14 enables the processor 15 to receive commands from the input device 13. In response to a command starting the interactive setup the processor 15 executes instructions contained in a rating limits application 16 in order to provide rating examples as described later on. The data for the display of introductions and rating examples are supplied to the on-screen display generator 17 for generating the respective screen displays, which are displayed on a display device 18, e.g. the television screen.

The input device 13 allows also entering user indications about the acceptability of the displayed rating examples. The selected acceptability grade is detected using the input interface 14 and is stored in a rating limits database 19, assigned to said recommended rating.

The rating examples database 12, the rating limits application 16 and the rating limits database 19 may be stored in the same memory device 10 but also in a combination of memory devices including random access memories (RAM), non-volatile or backup memories (e.g. programmable or flash memories), read only memories (ROM), and the like.

In a further embodiment, the rating examples database 12 is not generated in the receiver from data received within the EPG data stream but is permanently stored by the manufacturer in the receiver device. This is e.g. advantageous for devices which do not have an EPG feature or for EPG data streams where no additional capacity for transmitting rating example data is available. Although the examples may become out-of-date, this may not be a serious drawback, because TV sets etc. are typically bought and installed once and are seldom resold.

In a further embodiment involving networked devices, the rating examples database 12 is not stored within the device itself, but a remote server is accessed that stored this information, providing up-to-date examples, without sacrificing memory within the device itself.

In the above embodiments the user can automatically be provided with the rating examples, which provides the most guidance for the user.

In another embodiment, the rating examples are selected by the user from the normal EPG program schedule.

In another embodiment, currently broadcast programs are used as rating examples and ratings embedded into the currently broadcast programs are used as recommended ratings assigned to the rating examples.

The last two embodiments have the advantage that the user can pick out examples he or she definitely knows, which results in the most reliable ratings.

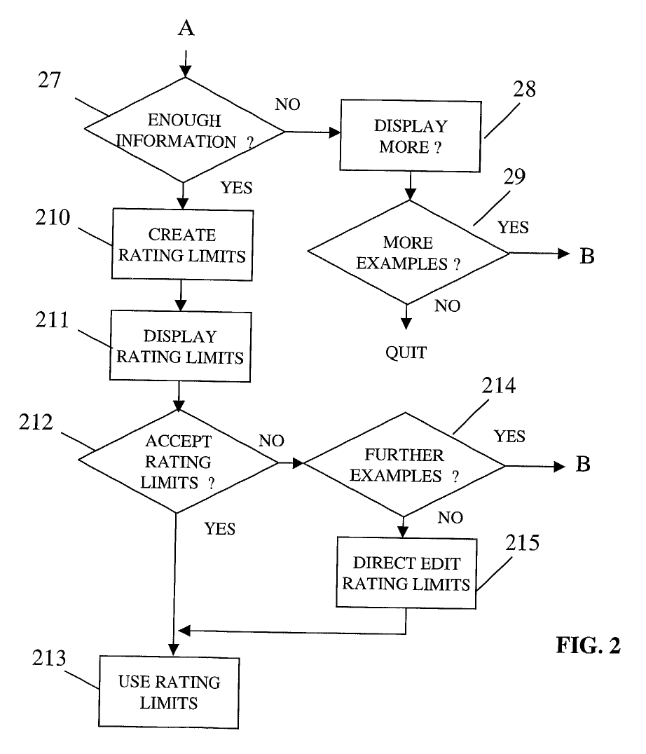

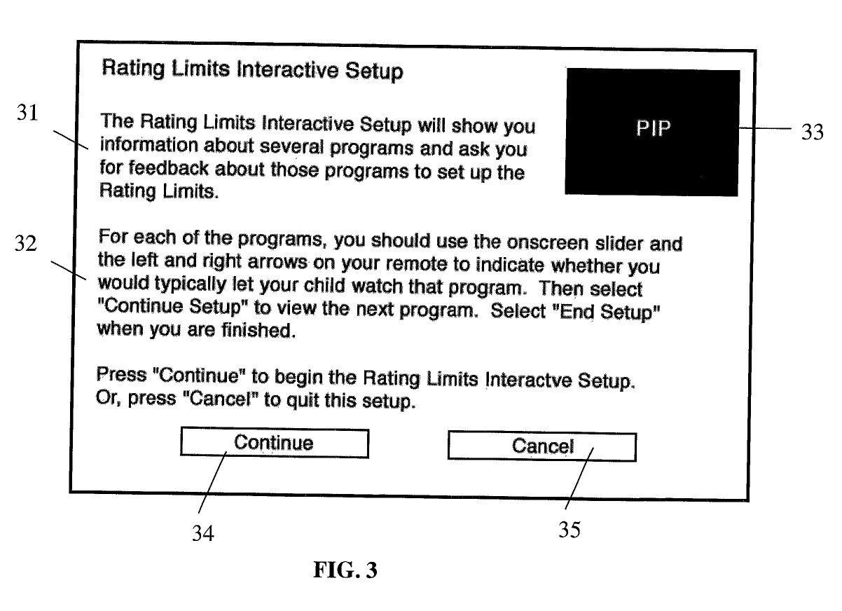

FIG. 2 shows a flow diagram of a method for the interactive setup. The method starts at step 21, with a typical on-screen display as shown in FIG. 3. An introduction is provided with explanations 31 of the rating limits interactive setup feature and instructions 32 for using the feature. During this first part of the interactive setup the video signal of the former viewed channel may still be displayed as a PIP 33. In order to start with the interactive rating of examples the user has to press the “Continue” button 34. However, the user can also select the “Cancel” button 35, if he or she wants to quit the rating limits setup.

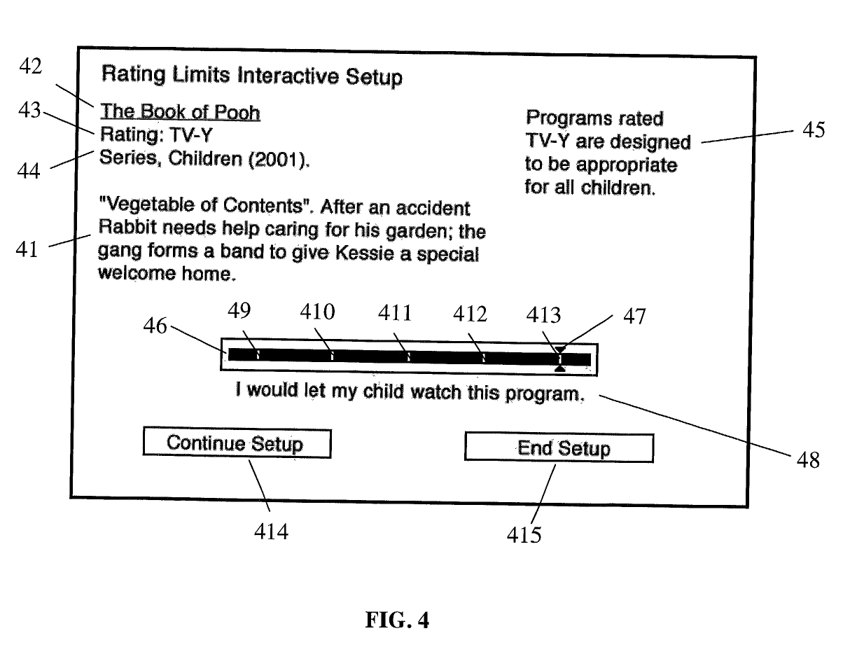

In step 22 the method may proceed along various paths depending on the user selection detected. If the user selects “Continue”, a rating example is displayed at step 23. The rating example is presented with a screen similar to that seen in FIG. 4. This screen presents the user with programming information for the program “The Book of Pooh”, including a description of the program 41, the program and episode titles 42, the ratings 43 and the topic and theme (Series, Children) 44. A legend 45 is located in the top, right corner of the screen, which provides an explanation of the rating assigned to that event. This help text changes with each program, and would always provide an explanation of the rating of the currently presented program.

The user's task is to use the on-screen slider 46 in the middle of the screen and the left and right arrow keys on the remote control to indicate whether he or she considers this program acceptable for viewing by the household children. As the indicator 47 on the slider moves to the left and right, the text 48 located beneath the slider would change to indicate the degree of acceptability. For example:

Left-most position 49 might indicate, “I would not let my child watch this program”.

Second position from the left 410 might indicate, “I might not let my child watch this program”.

Middle position 411 might indicate, “I do not know if I would let my child watch this program”.

Second position from the right 412 might indicate, “I might let my child watch this program”.

Right-most position 413 might indicate, “I would let my child watch this program”.

In the example above, the user has placed the indicator 47 at the right-most position 413, meaning that he or she would allow the household children to watch “The Book of Pooh”.

Once the user has selected a level of acceptability for viewing for that program, he or she may either select “Continue Setup” 414 or “End Setup” 415. As a result the system stores information regarding the rating level of the program, any content ratings that may be attached to the program, and the user's indication of acceptability at step 24.

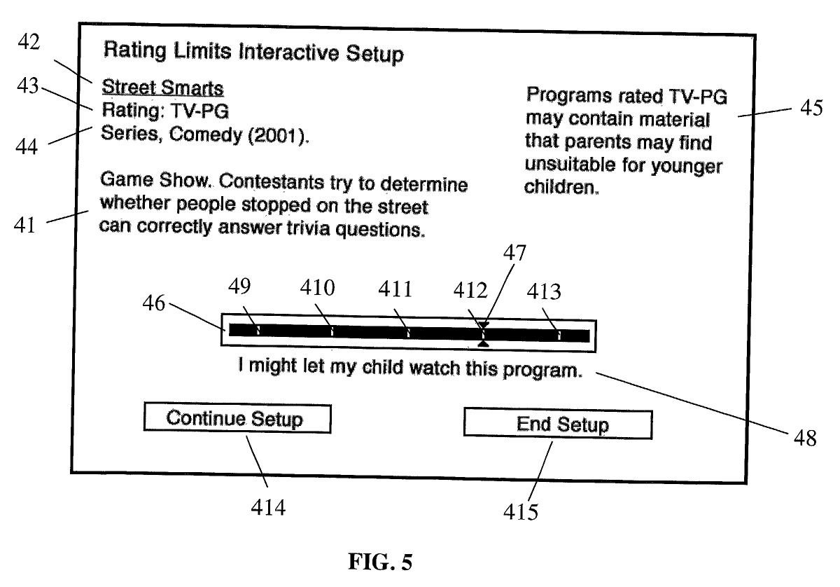

Then, depending on the detected selection regarding continuation of the setup the method divides up in step 25. If the user selected to continue the setup, the method returns to step 23, presenting another program to rate for viewing acceptability, as shown in FIG. 5. In this second example, the user has indicated that he or she might allow the children to watch “Street Smarts”.

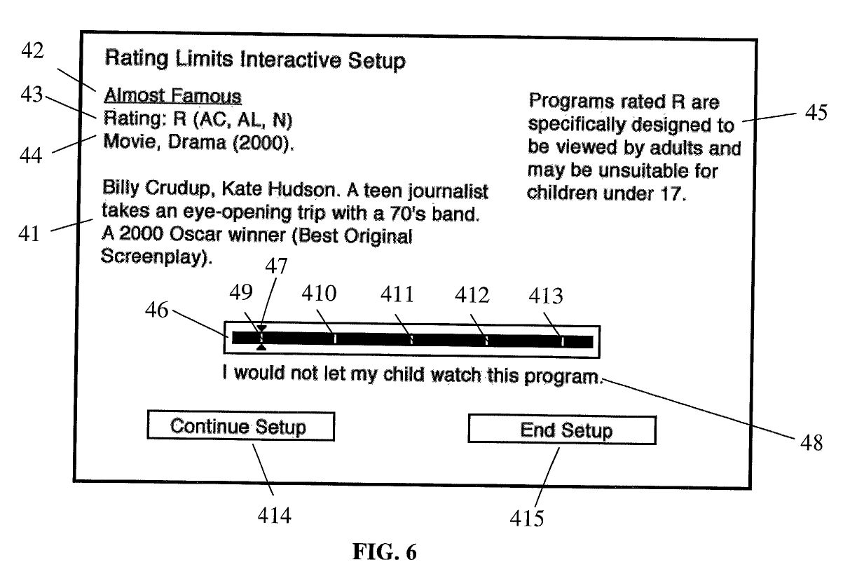

This process would continue until the user has rated several programs, and the system would continue to track the rating level of the program, any content ratings that might be attached to the program, and the user's indication of acceptability. After rating several programs in this manner, and when the user believes that he or she has rated a sufficient number of programs, he or she ends the setup routine by selecting the “End Setup” button 415. In the present example, the user has rated several programs, ending with the movie “Almost Famous”, which was deemed unacceptable for viewing as shown in FIG. 6, and has decided to end the setup routine.

Once the user selects the “End Setup” button 415, the method continues from step 25 to step 26 where the system aggregates all of the information it has acquired and determines whether there is enough information to accomplish the rating limits creation.

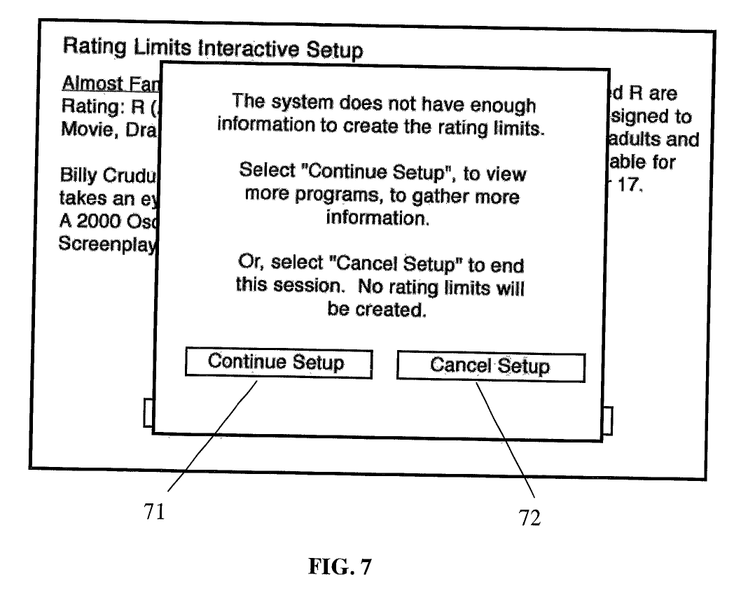

Depending on the result, the method may proceed along various paths after step 27. If the system determines that it does not have enough information, the user is presented in step 28 with a screen similar to that shown in FIG. 7, and has the option to either continue rating programs by selecting the “Continue Setup” button 71 or to quit the setup by selecting the “Cancel Setup” button 72. Accordingly, after step 29 the method continues either by returning to method step 23 or by quitting the setup.

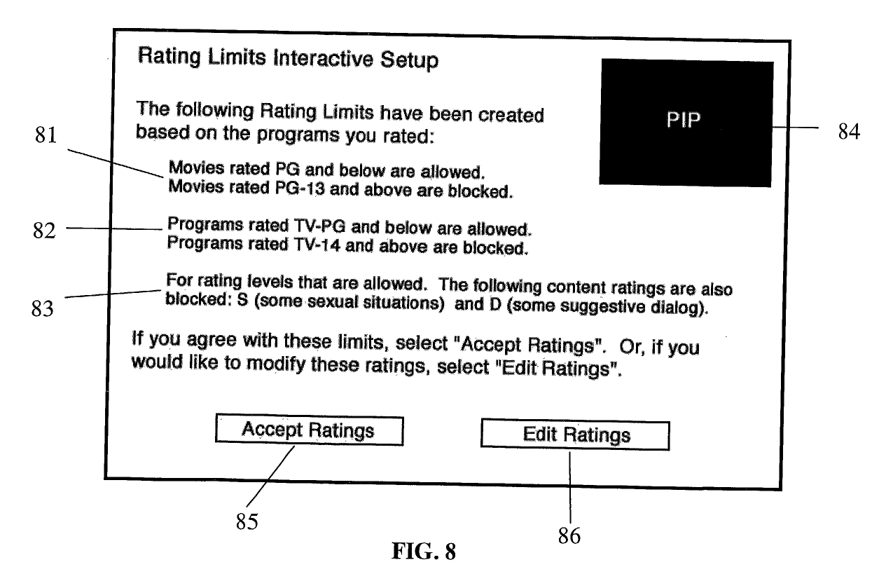

If the system does have enough information to create the rating limits, these rating are created in method step 210 and are presented to the user in method step 211, as is seen in FIG. 8. The defined movie rating limits 81, TV rating limits 82 and content ratings 83 summarized, while the program running on the selected background channel may now be displayed again as PIP 84.

The user then has the option to accept the rating limits as they are proposed using the “Accept Ratings” field 85, or to edit the rating limits after selecting “Edit Ratings” 86. Depending on the result the method divides up in step 212. If he or she chooses to accept the rating limits, the method proceeds to step 213 where these limits are from that point on compared against broadcast programs and allow viewing of only those programs that do not exceed the determined rating limits. If the user chooses to modify the rating, he or she has the choice of rating additional programs, or directly changing the rating scales. Correspondingly, the method divides up in step 214 and continues either in step 23 in the case of the rating of additional programs or in step 215 for changing the ratings via another screen.

In the step 26 of aggregating the acquired information and determining whether there are enough information to accomplish the rating limits creation, the following processes may be performed for improving the quality of the results.

For several evaluated rating examples having partially or totally the same recommended ratings, the user indications for these rating examples may be averaged.

User inputs may be requested until user indications for all ratings have been made. Instead, in order to accelerate the process user inputs may also be requested only until user indications for successive ratings have been determined, wherein one user indication is below a predefined limit and the other user indication is above the predefined limit. However, further user inputs for further rating examples may be requested, if a user indication for a rating corresponding to a higher level of recommended rating has a lower degree of acceptability than a user indication for a rating corresponding to a lower level of recommended rating. In this way it is ensured that the ratings are not applied if they are inconsistent, e.g. because of a misunderstanding of the interactive setup feature, an erroneous input or the use of the feature by an unsupervised child.

Numbers may be assigned to the different grades of acceptability, thus allowing easy averaging and comparison to predefined limits. For example, a user indication indicating the rating example as being definitely acceptable may correspond to a value of 1, a user indication indicating the rating example as being definitely not acceptable may correspond to a value of 0, and a predefined limit value may correspond to a value of 0.5. However, for a more restrictive evaluation the predefined limit may instead have a value close to 1.

When rating examples having different recommended ratings are automatically supplied to the user, which is more comfortable and may result in faster convergence, different strategies of providing the various examples are possible. Starting from a rating example with the lowest level of recommended rating the successive rating examples may have successively increasing levels of recommended rating. Also, starting from a rating example with the highest level of recommended rating the successive rating examples may have successively decreasing levels of recommended rating. Finally, starting with a rating example having an intermediate recommended rating, the successive rating example may have an increased level of recommended rating if the user indication for the first rating example is below a predefined limit and the successive rating example may have an decreased level of recommended rating if the user indication for the first rating example is above a predefined limit.

In the case of an user indication corresponding to an intermediate degree of acceptability, the next rating example may be chosen having partially the same recommended rating, e.g. having the same age-based rating but different content-based ratings, or having totally the same recommended rating. This may be advantageous if a user does not know the first example and therefore chose an intermediate degree of acceptability. After several user indications corresponding to an intermediate degree of acceptability for several successive rating examples having the same recommended rating the next rating example may be chosen having a different recommended rating. This may be advantageous if the user is really undecided for example with this certain recommended rating.

The invention simplifies the process of setting up rating limits by providing the user with concrete examples of programs that he or she may want to allow or block, thus eliminating errors caused by the abstractness of the ratings. This can be used in consumer electronic devices like television sets, set-top boxes, VCRs, PVRs or DVD players. However, provided that suited rating limits are specified, the invention can also be used for blocking certain games on game consoles or for content filtering of Internet web sites, chat and news groups and emails.

The invention may be implemented in hardware or software, wherein a software implementation could be part of the operating system but could also be distributed and installed as a separate program.

What is claimed, is:

1. A method for selecting rating limits in a program content filtering system, wherein said rating limits define whether programs are to be blocked or are deemed to be acceptable, comprising:
reproducing information about a rating example;
supplying at least one recommended rating assigned to said rating example;
detecting an user indication about the acceptability of said rating example;
assigning said user indication to said recommended rating; and
deriving a rating limit in response to assigning said user indication to said recommended rating.

2. The method of claim 1 wherein the steps of reproducing, supplying, detecting and assigning are repeated for a plurality of rating examples and a respective plurality of recommended ratings to provide a plurality of user indications for said plurality of recommended ratings and a plurality of assignments of said plurality of user indications to respective ones of said plurality of recommended ratings, and wherein the step of deriving a rating limit occurs in response to said plurality of assignments.

3. The method in accordance with claim 1, further comprising the steps of:
storing said rating limits;
receiving programs comprising multimedia content and assigned recommended ratings;
comparing said stored rating limits with said received assigned recommended ratings; and
denying access to programs exceeding at least one of the rating limits.

4. The method in accordance with claim 1, wherein said programs are television programs and wherein said program content filtering system is a parental control system.

5. The method in accordance with claim 4, wherein said television programs are received as an analogue television signal and said assigned recommended ratings are received in the vertical blanking interval of said analogue television signal.

6. The method in accordance with claim 1, wherein the recommended ratings define the age of the viewer the program is designed for, the degree of a certain program content, or a combination thereof.

7. The method in accordance with claim 1, wherein the reproduced information about the rating examples is displayed to the user and comprises one or more of the following:
Title, description, topics, theme, picture, summary, short trailer, recommended rating, explanation of recommended rating.

8. The method in accordance with claim 1, wherein said user indications comprise various degrees of acceptability.

9. The method in accordance with claim 1, wherein said information about rating examples and said recommended ratings assigned to said rating examples are received within electronic program guide information.

10. The method in accordance with claim 1, wherein said information about rating examples and said recommended ratings assigned to said rating examples are stored in a receiver device.

11. The method in accordance with claim 1, wherein for a networked device said information about rating examples and said recommended ratings assigned to said rating examples are stored in a remote server.

12. The method in accordance with claim 1, wherein said information about rating examples and said recommended ratings assigned to said rating examples are selected by the user from the normal EPG program schedule.

13. The method in accordance with claim 1, wherein currently broadcasted programs are used as information about rating examples and wherein recommended ratings broadcast embedded into said currently broadcast programs are used as said recommended ratings assigned to said rating examples.

14. The method in accordance with claim 1, wherein an overview of derived rating limits is displayed.

15. The method in accordance with claim 14, wherein the derived rating limits can be manually amended.

16. Apparatus comprising:
means for receiving programming including rating information; and
control means responsive to the rating information and to a rating limit for providing content filtering of the programming; wherein the control means comprises:
means for providing information about a rating example; and
means for deriving the rating limit in response to an indication from a user about the acceptability of the rating example.

17. The apparatus of claim 16 wherein the information providing means provides information about a plurality of rating examples and the rating limit deriving means derives the rating limit in response to a plurality of indications from a user about the acceptability of respective ones of the plurality of rating examples.

18. Television apparatus with a parental control system, comprising:
a processor for executing a rating limits application, wherein said rating limits application provides rating examples and processes user indication about the acceptability of said rating examples in order derive rating limits from said user indications;
an OSD generator for generating screen displays reproducing information about said rating examples;
a display for displaying said screen displays;
an input interface for detecting user indications about the acceptability of said rating examples; and
a memory for storing said derived rating limits.
